(19) United States
(12) Patent Application Publication
(10) Pub. No.: US 2011/0111078 A1
(43) Pub. Date: May 12, 2011

(54) EXTRUSION HEAD FOR PLASTIC MATERIALS

(75) Inventor: Sergio Boccafogli, Bologna (IT)

(73) Assignee: S.I.M.A.

(21) Appl. No.: 12/678,077

(22) PCT Filed: Aug. 13, 2007
(86) PCT No.: PCT/IT07/00637

§ 371 Date: Jan. 27, 2011

(51) Int. Cl. B29C 47/12; B29C 47/30; B29C 47/58

(52) U.S. Cl. 425/376.1

(57) ABSTRACT

An extrusion head for plastic materials. The extrusion head is characterized in that a distribution plate is interchangeable. The distribution plate includes at least one distribution network for the extruded materials, so as to determine the characteristics of at least one type of type produced by the extrusion operation through its conformation.

### TECHNICAL FIELD

The present invention concerns an extrusion head for plastic materials.

In particular, this extrusion head can be used for the coextrusion of two materials having different chemical-physical and/or colorimetric characteristics.

### BACKGROUND ART

It is known that very thin strips of plastic material, known as tapes, are used in the creation of artificial.

In order that artificial grass approximates to natural grass in a credible manner, from a visual standpoint, it is important that the tapes do not all have the same colour.

For example, each tape can have a first face with a first colour (e.g. dark green), and a second face with a second colour (e.g. light green).

As shall be seen, by means of the extrusion head, the subject of the present invention, it is possible to obtain tapes having the colouring of a first material, the colouring of a second material, or a first face coloured according to a first material and a second face with the colour of a second material, by simply changing a distribution plate.

### DISCLOSURE OF INVENTION

Thus, according to the present invention, an extrusion head is embodied in accordance with the enclosed claims.

### BRIEF DESCRIPTION OF THE DRAWINGS

The present invention shall now be described with reference to the enclosed drawings, which illustrate non-limitative examples of embodiment, where:

FIG. 1 illustrates a section A-A of a first embodiment of an extrusion head, the subject of the present invention,

FIG. 2 shows a view C-C of a detail of the extrusion head in FIG. 1,

FIG. 3 illustrates a section B-B of the extrusion head shown in FIGS. 1 and 2,

FIG. 4 shows a view D-D of a detail of the extrusion head illustrated in FIGS. 1, 2 and 3,

FIG. 5 illustrates a view E-E of a detail of the extrusion head illustrated in FIGS. 1, 2, 3 and 4,

FIG. 6 shows a section F-F of a second embodiment of an extrusion head, the subject of the present invention,

FIG. 7 illustrates a view G-G of a detail of the extrusion head in FIG. 6,

FIG. 8 shows a view H-H of a detail of the extrusion head illustrated in FIGS. 6 and 7,

FIG. 9 illustrates a view I-I of a detail of the extrusion head illustrated in FIGS. 6, 7 and 8,

FIG. 10 shows a section L-L of a third embodiment of an extrusion head, the subject of the present invention,

FIG. 11 illustrates a view M-M of a detail of the extrusion head in FIG. 10,

FIG. 12 shows a view N-N of a detail of the extrusion head illustrated in FIGS. 10 and 11, and

FIG. 13 illustrates a view O-O of a detail of the extrusion head illustrated in FIGS. 10, 11 and 12.

### BEST MODE FOR CARRYING OUT THE INVENTION

In FIGS. 1, 2, 3, 4 and 5, reference numeral 100 indicates, in its entirety, a first embodiment of an extrusion head for plastic materials, the subject of the present invention.

The extrusion head 100 comprises, from the top downwards:
a spacer element 101
a first distribution plate 102,
a second distribution plate 103,
a third distribution plate 104,
a preform die 105, and
a die 106
   packed one on top of the other and held together by clamping means (e.g. clamping screws) that are not shown in the enclosed figures so as not to compromise legibility.

Representations of the electrical resistances that serve to heat the extrusion head 100 to keep the plastic materials to be extruded in the fluid state have also been omitted from the enclosed drawings.

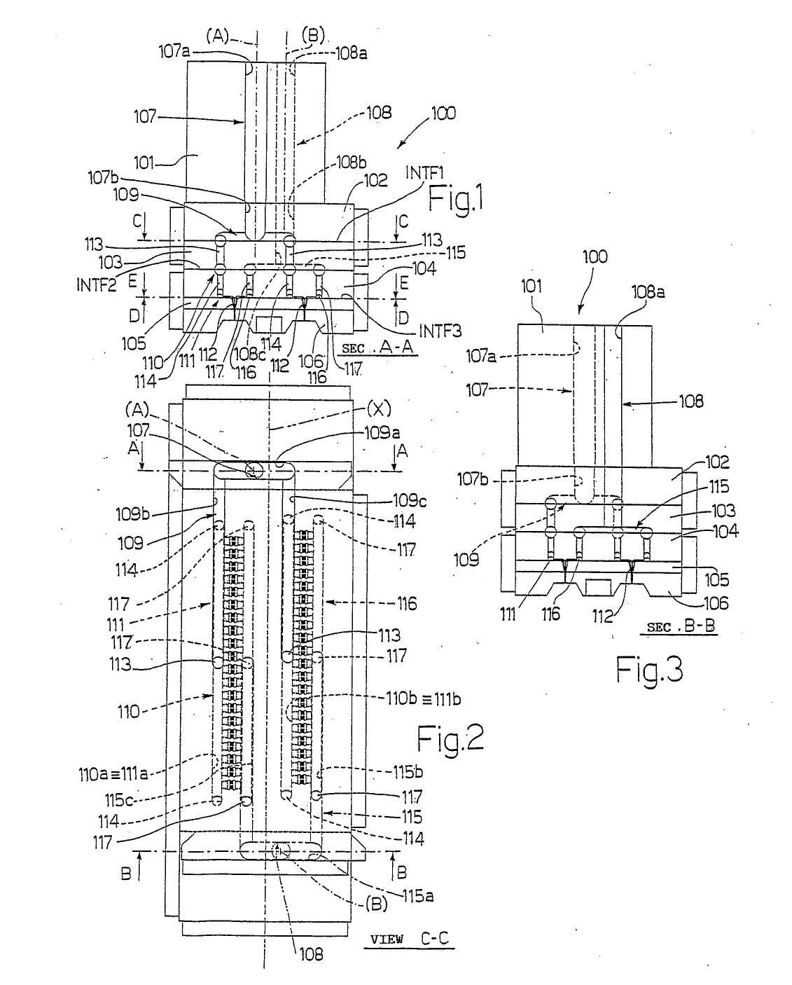

The various elements packed one on top of the other are substantially symmetrical with respect to a plane, which is traced on the drawing sheet as axis (X) (FIG. 2).

The spacer element 101 is provided with two inlet channels for two different plastic materials. These different plastic materials can have different chemical-physical characteristics and/or different colours.

Entering into greater detail, a duct 107a having a respective longitudinal axis of symmetry (A) and a duct 108a having a respective longitudinal axis of symmetry (B), have been created in the substantially parallelepipedal spacer element 101.

The ducts 107a-108a are the terminal portions of the feed channels (not shown) of two different plastic materials in the semi-liquid state.

As shall be better seen in the following, duct 107a is able to convey a first plastic product having, for example, a first colour, while a second plastic product having, for example, a second colour, flows through the second duct 108a.

In series with duct 107a there is a duct 107b made in the first distribution plate 102, such that the set of the two ducts 107a-107b in series form a feed channel 107 (with axis (A)) for the first product.

Similarly, in series with duct 108a there is a second duct 108b, made in the first distribution plate 102, and a third duct 108c obtained in the third distribution plate 103. the set of ducts 108a-108b-108c in series form a feed channel 108 (with axis (B)) in which the second product flows, which, as already mentioned, generally has different chemical-physical and/or colorimetric characteristics from the first product.

A first distribution network 109 for the first product is made in an interface INTF1 between the first distribution plate 102 and the second distribution plate 103. This first distribution network 109 has a U-shape, with a branch 109a transversal to axis (X) and two branches 109b-109c parallel to the same axis (X).

Furthermore, between the second distribution plate 103 and the third distribution plate 104, there is an interface INTF2 in which there is a second distribution network 110 for the first product including two branches 110a-110b both parallel to axis (X).

Similarly to that seen above, a third distribution network 111, always for the first product, is allocated in an interface INTF3 between the third distribution plate 104 and the preform die 105.

In turn, the third distribution network 111 includes two branches 111a, 111b.

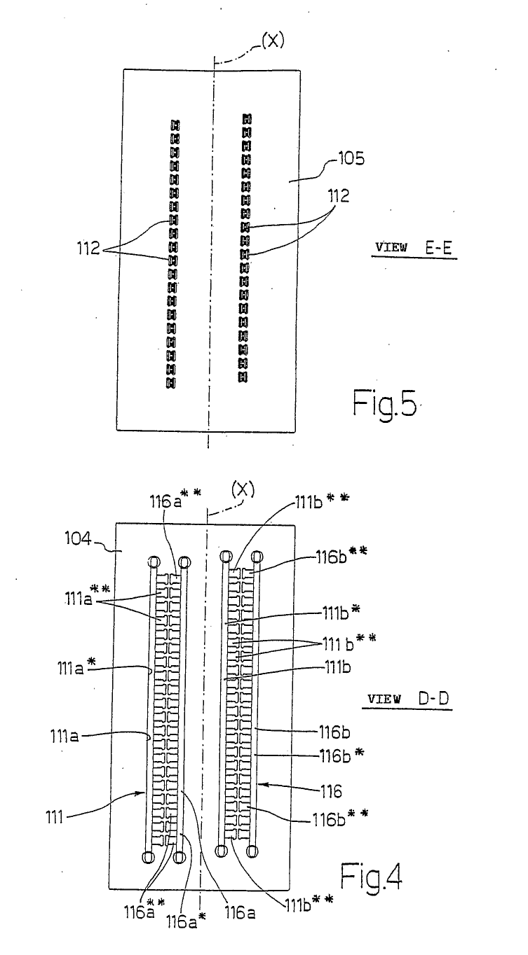

Branch 111a (FIG. 4) comprises a duct 111a* parallel to axis (X) and a plurality of ducts 111a** perpendicular to the same axis (X). Each duct 111a** terminates in a respective extrusion outlet 112 (FIG. 5) from which the first finished extruded product emerges. The extrusion outlet 112 has the shape of a slit parallel to axis (A) and affects the preform die 105 and the die 106.

Similarly, branch 111b comprises a duct 111b* parallel to axis (X) and a plurality of ducts 111b** perpendicular to the same axis (X). Each duct 111b** terminates in a respective extrusion outlet 112 from which the finished extruded product emerges.

As shown, always in FIGS. 1, 2, 3, 4 and 5, the first distribution network 109 for the first product is connected to the second distribution network 110 for the same product via a plurality of vertical conduits 113, parallel to axis (A) (FIG. 1).

Furthermore, a plurality of conduits 114, these also vertical and parallel to axis (A), is provided between the second distribution network 110 for the first product and the third distribution network 111. Each conduit 114 is the continuation of the respective conduit 113.

The feed channel 108 for the second product terminates in a fourth distribution network 115 situated in the interface INTF2 between the second distribution plate 103 and the third distribution plate 104.

The fourth distribution network 115 for the second product is U-shaped and is identical to the first distribution network 109. This fourth distribution network 115 therefore has a branch 115a transversal to axis (X) and two branches 115b-115c parallel to the same axis (X).

Furthermore, branches 115b and 115c of the fourth distribution network 115 for the second product are parallel to branches 110a and 110b of the second distribution network 110.

Moreover, a fifth distribution network 116, always for the second product, is situated in the interface INTF3 between the third distribution plate 104 and the preform die 105.

In turn, the fifth distribution network 116 includes two branches 116a, 116b.

Branch 116a comprises a duct 116a* parallel to axis (X) and a plurality of ducts 116a** perpendicular to the same axis (X). Each duct 116a** terminates in a respective extrusion outlet 112 from which the second finished extruded product emerges.

Similarly, branch 116b comprises a duct 116b* parallel to axis (X) and a plurality of ducts 116b** perpendicular to the same axis (X). Each duct 116b** terminates in a respective extrusion outlet 112 from which the finished extruded product emerges.

In other words, each duct 111a** (in which the first product is extruded) faces a respective duct 116a** (in which the second product is extruded) and each duct 111b** (in which the first product is extruded) finds itself facing a respective duct 116b** (through which the second product is extruded).

In addition, each pair formed by ducts 111a** and 116a**, and, respectively, by ducts 111b** and 116b** flow into the same respective coextrusion outlet 112 for the two materials, so as to obtain, for example, tape with different coloured faces.

A plurality of conduits 117, these also vertical and parallel to axis (B), is provided between the fourth distribution network 115 for the second product and the fifth distribution network 116.

It should be noted that the outlet 112 in the first embodiment shown in FIGS. 1, 2, 3, 4 and 5 is the same for the two products to be extruded.

In this way, as they are coextruded in the outlets 112, the two products form tapes, each having two faces with different properties, such as different colours for example.

The problem of simultaneously coextruding two plastic materials having different characteristics using the same outlets 112 is thus resolved in a simple and inspired manner.

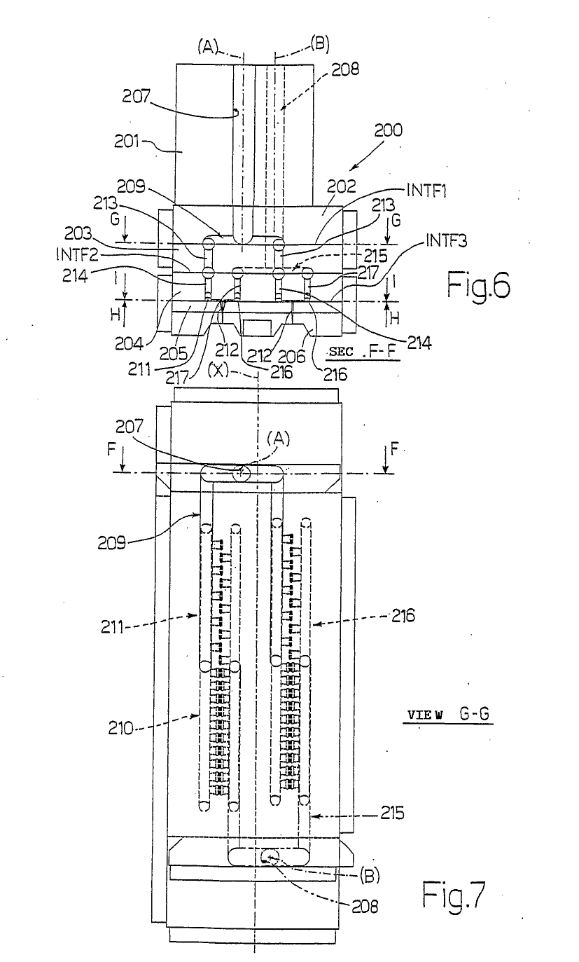

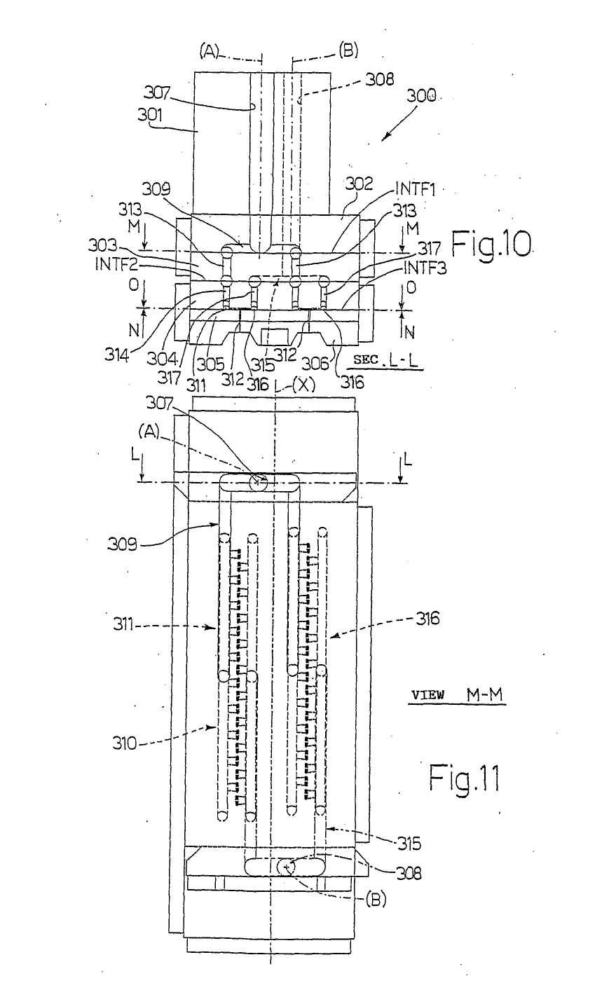

In the second embodiment shown in FIGS. 6, 7, 8 and 9, a third distribution plate 204, different from the distribution plate 104 previously described with reference to the first embodiment illustrated in FIGS. 1, 2, 3, 4 and 5, has been adopted in an extrusion head 200.

In FIGS. 6, 7, 8 and 9, the first figure of the reference numbers has been changed to “2” because they substantially indicate the same elements regarding the first embodiment shown in FIGS. 1, 2, 3, 4 and 5.

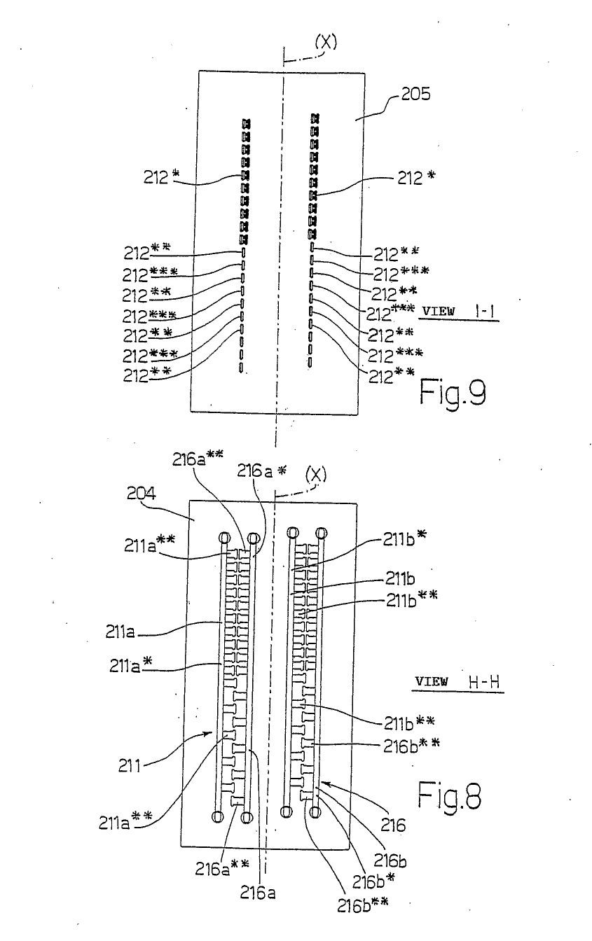

In fact, in this case, a third distribution network 211 (FIG. 8) for a first product includes, in turn, two branches 211a-211b. Branch 211a comprises a duct 211a* parallel to axis (X) and a plurality of ducts 211a** perpendicular to the same axis (X) that are not equally spaced out between each other. Each duct 211a** terminates in a respective extrusion outlet 212* or 212**.

Incidentally, it should be noted that the extrusion outlets in which the second product is also coextruded with the system seen in the first embodiment are identified by reference number 212*, while 212** indicates the extrusion outlets in which only the first product is extruded.

Similarly, branch 211b comprises a duct 211b* parallel to axis (X) and a plurality of ducts 211b** perpendicular to the same axis (X) that are not equally spaced out between each other. Each duct 211b** terminates in a respective extrusion outlet 212* or 212** from which the finished extruded product emerges.

Regarding the second plastic product, the fifth distribution network 216 has two branches 216a and 216b. Branch 216a comprises a duct 216a* parallel to axis (X) and a plurality of ducts 216a** perpendicular to the same axis (X) that are not equally spaced out between each other.

Each duct 216a** terminates in a respective coextrusion outlet 212*, or terminates in a respective outlet 212*** from which only the second finished extruded product emerges.

As can be noted from observation of FIG. 8, outlets 212** (for extrusion of just the first product) are inserted in between outlets 212*** (for extrusion of just the second product).

Similarly, branch 216b comprises a duct 216b* parallel to axis (X) and a plurality of ducts 216b** perpendicular to the same axis (X). Each duct 216b** terminates in a respective coextrusion outlet 212* or 212***, or terminates in a respective outlet 212*** from which only the second finished extruded product emerges.

Outlets 212** (for extrusion of just the first product) are inserted in between outlets 212*** (for extrusion of just the second product).

Incidentally, it should be noted that the extrusion outlets in which both products are simultaneously coextruded with the system seen in the first embodiment are identified by reference number 212*, while tapes made with just the first product emerge from extrusion outlets 212** and outlets 212*** are the extrusion outlets in which only the second product is extruded.

Furthermore, the coextrusion outlets 212* of both products are positioned all in a row, one behind the other, while the extrusion outlets 212** for just the first product are inserted in between the extrusion outlets 212*** for just the second product.

Consequently, there is a first series of coextruded tapes having faces made with two different products, a second series of tapes made only with the first product and a third series of tapes obtained by extrusion of just the second product.

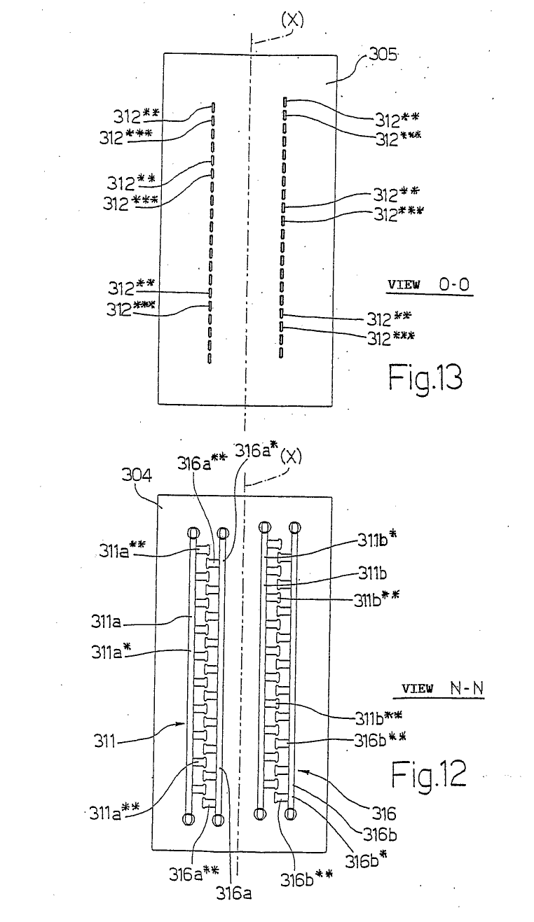

In the third embodiment shown in FIGS. 10, 11, 12 and 13, a third distribution plate 304, different from the third distribution plate 104 previously described with reference to the first embodiment illustrated in FIGS. 1, 2, 3, 4 and 5, has been adopted in an extrusion head 300. Furthermore, the third distribution plate 304 is also different from the third distribution plate 204 utilized in the second embodiment of present invention and described with reference to FIGS. 6, 7, 8 and 9.

In FIGS. 10, 11, 12 and 13, the first figure of the reference numbers has been changed to “3” because they substantially indicate the same elements regarding the first embodiment shown in FIGS. 1, 2, 3, 4 and 5, and the second embodiment illustrated in FIGS. 6, 7, 8 and 9.

In the third embodiment (FIGS. 10, 11, 12 and 13), extrusion outlets 312** alternating with extrusion outlets 312*** (FIGS. 12 and 13) are provided in the manner seen for the second embodiment. As the solution adopted in the third embodiment is substantially identical to part of that described in the second embodiment with regard to extrusion outlets 212** and 212***, to not make the present description overlong, please refer to the description concerning the second embodiment shown in FIGS. 6, 7, 8 and 9.

It is also important to note that one of the most interesting characteristics of the extrusion head 100, 200 and 300, the subject of the present invention, consists in the fact that simply changing the third distribution plate 104 (FIG. 1), 204 (FIG. 6) and 304 (FIG. 10) results in producing tapes with different characteristics.

The main advantage of the extrusion head, the subject of the present invention, consists in its extreme versatility, due to the fact that by simply changing a distribution plate for the plastic materials in the semi-liquid state, tapes are obtained that have different characteristics and which can be used, for example, to create artificial grass with a very pleasing visual effect, and in all those cases where dual colouring of the same monofilament is required. Furthermore, considering that the monofilaments are wound onto reels, with the system in question it is possible to produce reels with different colours or combinations of threads with colour A and colour B in a single winding operation, avoiding further production steps that without the aid of the head in question, must instead be carried out. However, neither should the high flexibility of the system be overlooked, which ensures unlimited choice in the ratio of the number of threads with different colours and the winding method.

1. Extrusion head for plastic materials including:
distribution means; and
extrusion means, with said distribution means and said extrusion means being packed one on top of the other and held together by clamping means,
wherein at least one distribution plate, belonging to said distribution means, is interchangeable, and in that said at least one distribution plate includes at least one distribution network for the materials to extrude, such that the characteristics of at least one tape are determined by the conformation of said distribution network.

2. Extrusion head, as claimed in claim 1, wherein it includes:
a spacer element;
a first distribution plate;
a second distribution plate;
a third distribution plate;
a preform die; and
a die,
wherein the spacer element, the first distribution plate, the second distribution plate, the third distribution plate and the perform die and the die are packed one on top of the other and held together by clamping means.

3. Extrusion head, as claimed in claim 1, wherein said at least one distribution network for a first product comprises two branches, with a first branch, in turn, including a first duct, parallel to a longitudinal axis of symmetry (X), and a first plurality of ducts perpendicular to the same axis (X), in which each duct terminates in a respective extrusion outlet, and with a second branch including a second duct parallel to axis (X) and a second plurality of ducts perpendicular to the same axis (X), in which each duct terminates in a respective extrusion outlet.

4. Extrusion head, as claimed in claim 3, wherein it also includes a second distribution network for a second product comprising a further two branches, with a third branch, in turn, including a third duct, parallel to axis (X), and a third plurality of ducts perpendicular to the same axis (X), in which each duct terminates in a respective extrusion outlet in which a respective duct of said distribution network also terminates, so as to achieve coextrusion of the first product and the second product in each of their respective extrusion outlets, and with a fourth branch including a fourth duct parallel to axis (X) and a fourth plurality of ducts perpendicular to the same axis (X), in which each duct terminates in a respective extrusion outlet in which a respective duct of said distribution network also terminates, so as to achieve coextrusion of the first product and the second product in the extrusion outlet itself.

5. Extrusion head, as claimed in claim 4, wherein the distribution network for the first product is fed by means of a feed channel, by means of a further distribution network and by means of conduits, and in that the second distribution network for the second product is fed by means of a second feed channel, by means of a second further distribution network and by means of second conduits.

6. Extrusion head, as claimed in claim 1, wherein said at least one distribution network for a first product comprises two branches, with a first branch, in turn, including a first duct parallel to a longitudinal axis of symmetry (X), and a first plurality of ducts perpendicular to the same axis (X) that are not equally spaced out between each other, in which each duct terminates in a respective extrusion outlet, and with a second branch including a second duct parallel to axis (X) and a second plurality of ducts perpendicular to the same axis (X) that are not equally spaced out between each other, in which each duct terminates in a respective extrusion outlet.

7. Extrusion head, as claimed in claim 6, wherein it also includes a second distribution network for a second product comprising a further two branches, with a third branch, in turn, including a third duct parallel to axis (X), and a third plurality of ducts perpendicular to the same axis (X) that are not equally spaced out between each other, in which each duct terminates in a respective coextrusion outlet, or terminating in a respective outlet from which only the second finished extruded product emerges, and with a fourth branch including a fourth duct parallel to axis (X) and a fourth plurality of ducts perpendicular to the same axis (X), in which each duct terminates in a respective coextrusion outlet in which a respective duct of said distribution network also terminates, or terminates in a respective outlet from which only the second finished extruded product emerges.

8. Extrusion head, as claimed in claim 7, wherein the distribution network for the first product is fed by means of a feed channel, by means of a further distribution network and by means of conduits, and in that the second distribution network for the second product is fed by means of a second feed channel, by means of a second further distribution network and by means of a second set of conduits.

9. Extrusion head, as claimed in claim 7, wherein extrusion outlets are coextrusion outlets for both products, extrusion outlets are extrusion outlets for just the first product, while extrusion outlets are extrusion outlets for just the second product.

10. Extrusion head, as claimed in claim 9, wherein the outlets for extrusion of just the first product are inserted in between the outlets for extrusion of just the second product.

11. Extrusion head, as claimed in claim 1, wherein said at least one distribution network for a first product comprises two branches, with a first branch, in turn, including a first duct parallel to a longitudinal axis of symmetry (X), and a first plurality of ducts perpendicular to the same axis (X), in which each duct terminates in a respective extrusion outlet, and with second branch (311b) including a second duct parallel to axis (X) and a second plurality of ducts perpendicular to the same axis (X), in which each duct terminates in a respective extrusion outlet from which only the first extruded product emerges.

12. Extrusion head, as claimed in claim 11, wherein it also includes a second distribution network for a second product comprising a further two branches, with a third branch, in turn, including a third duct parallel to axis (X), and a third plurality of ducts perpendicular to the same axis (X), in which each duct terminates in a respective outlet from which only the second finished extruded product emerges, and with a fourth branch including a fourth duct parallel to axis (X) and a forth plurality of ducts perpendicular to the same axis (X), in which each duct terminates in a respective outlet from which only the second finished extruded product emerges.

13. Extrusion head, as claimed in claim 12, wherein the distribution network for the first product is fed by means of a feed channel, by means of a further distribution network and by means of conduits, and in that the second distribution network for the second product is fed by means of second a feed channel (308), by means of a second further distribution network and by means of a second set of conduits.

14. Extrusion head, as claimed in claim 12, wherein the extrusion outlets of the first branch are the extrusion outlets for just the first product, while the extrusion outlets of the second branch are the extrusion outlets for just the second product.

15. Extrusion head, as claimed in claim 14, wherein the outlets for extrusion of just the first product are inserted in between the outlets for extrusion of just the second product.

16. An apparatus for extruding plastic materials comprising:
at least one distribution plate defining a first inlet channel to receive a first fluidic material and distribute the first fluidic material to a first distribution network and a second inlet channel to receive a second fluidic material and to distribute the second fluidic material to a second distribution network; and
at least one die defining a plurality of extrusion outlets, with a first portion of each extrusion outlet in fluid communication with the first distribution network, and with a second portion of each extrusion outlet in fluid communication with the second distribution network, with each extrusion outlet shaped to extrude a tape with a first side formed of the first fluidic material and the second side formed of the second fluidic material.

17. The apparatus of claim 16, wherein the at least one distribution plate includes:
a first distribution plate coupled to the spacer element;
a second distribution plate coupled to the first distribution plate; and
a third distribution plate coupled to the second distribution plate,
wherein the first network is defined by the first, second and third plates and the second distribution network is defined by the second and third plates.

18. The apparatus of claim 17, wherein the at least one die includes:
a preform die; and
a die coupled to the perform die,
wherein the perform die and the die together define each extrusion outlet.

19. the apparatus of claim 16, wherein the at least one die defines a second plurality of extrusion outlets coupled only to the first distribution network, the second plurality of extrusion outlets to make a tape formed of only the first fluidic material.

20. the apparatus of claim 16, wherein the at least one die defines a third plurality of extrusion outlets coupled only to the second distribution network, the third plurality of extrusion outlets to make a tape formed of only the second fluidic material.
